(19) United States
(12) Patent Application Publication
(10) Pub. No.: US 2025/0181052 A1
(43) Pub. Date: Jun. 5, 2025

(54) METHOD AND SYSTEM FOR PREDICTING COLLISION DETECTION OF MOVING PATH OF MACHINE TOOL

(71) Applicant: Industrial Technology Research Institute, Hsinchu (TW)

(72) Inventors: CHAO-CHUANG MAI, Taichung County (TW); MING-CHUN HO, Taichung City (TW); CHE-WEI HSU, Taichung City (TW)

(21) Appl. No.: 18/392,296

(22) Filed: Dec. 21, 2023

(30) Foreign Application Priority Data
Dec. 5, 2023 (TW) 112147163

(51) Int. Cl. G05B 19/4061

(52) U.S. Cl. CPC G05B 19/4061

(57) ABSTRACT

A method for predicting collision detection of moving path of machine tool includes the following steps. Firstly, the motion information of a processing unit is acquired through the data acquisition unit. Then, based on the motion information, the arithmetic unit calculates the stop position of the processing unit after deceleration; and, further based on the stop position of the processing unit, the collision detection unit performs anti-collision detection to compare the stop position of the processing unit and the workpiece position of the workpiece. In additional, a system for predicting collision detection of moving path of machine tool is also provided.

### CROSS REFERENCE TO RELATED APPLICATION

This application claims the benefits of Taiwan application Serial No. 112147163, filed on Dec. 5, 2023, the disclosures of which are incorporated by references herein in its entirety.

### TECHNICAL FIELD

The present disclosure relates in general to a method and system for predicting collision detection of moving path of machine tool.

### BACKGROUND

Through intelligence, manufacturers can achieve a variety of applications, such as reducing energy consumption for achieving low carbonization, establishing machine maintenance technology, etc. In particular, with the development of diversified machine tool models, the multi-axis composite trend has complicated relative operations, and the processing path generated by planning is further complicated. Now, it is obviously difficult to detect collisions using manual detection methods.

Common technologies for anti-collision detection at least include: external computer simulation detection, idle motion detection and online detection. The external computer simulation detection method needs to cooperate with external instruments such as lenses, sensors, etc., which consumes excessive system resources for external testing, and data transmission between instrument and controllers. The method of dry motion detection is to run a simulation exercise process of the machining path without setting up the tool. However, this method requires first obtaining the interpolation command through interpolation calculation in order to execute the machining path, so additional system resources must be consumed to perform idle motion detection. The online detection method uses the virtual machine tool motion model and the controller communication interface to implement online real-time collision detection. The machine can be stopped before a collision occurs. This method cannot ensure the deceleration distance, and thus, even the machine tool can stop prior to a collision, it is still possible a collision to occur after the machine is stop.

In addition, the above-mentioned anti-collision mechanisms are all performed in the automatic mode of the automated process and cannot be applied to the manual mode. The manual mode provides the operator with machine tool move commands through the control panel to achieve machine calibration and create automated processes. However, this manual mode may cause collision losses due to human error, thereby causing downtime and reduced availability.

### SUMMARY

An object of the present disclosure is to provide a method and system for predicting collision detection of moving path of machine tool that can detect the collision in advance, such that the unexpected collision can be predicted to avoid collision damage but increase the processing utilization rate.

In one embodiment of this disclosure, a method for predicting collision detection of moving path of machine tool, applicable to connect a machine tool to be operated by a computer, the machine tool including a controller, the controller including at least one processing unit, comprises the steps of: utilizing a data acquisition unit to capture a motion information of the at least one processing unit, the motion information including a current machine coordinate parameter, a motion axial feed parameter and a system response time parameter; according to the motion information, utilizing an arithmetic unit to calculate a stop position of the at least one processing unit after being decelerated; and, according to the stop position of the at least one processing unit, utilizing a collision detection unit to perform an anti-collision detection, comparing the stop position of the at least one processing unit with a workpiece position of a workpiece.

In another embodiment of this disclosure, a system for predicting collision detection of moving path of machine tool, applicable to connect a machine tool, the machine tool including a controller, the controller including at least one processing unit, comprises: a data acquisition unit, configured for capturing a motion information of the at least one processing unit; an arithmetic unit, signally connected with the data acquisition unit, configured for receiving the motion information and calculating a stop position of the at least one processing unit after being decelerated according to the motion information; and, a collision detection unit, signally connected with the arithmetic unit, configured for performing an anti-collision detection the collision detection unit according to the stop position of the at least one processing unit and comparing the position of the at least one processing unit and a workpiece position of a workpiece.

As stated, the method and system for predicting collision detection of moving path of machine tool provided in this disclosure can detect collisions in advance so as able to predict a stop position after a deceleration and further ensure to avoid an unexpected collision. In addition, the method and system can prevent an improper path scheme with irrelevant machine tool move commands in the manual mode from damaging the machine tool or the workpiece. Namely, the processing utilization rate can be substantially maintained.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic view of the system for predicting collision detection of moving path of machine tool in accordance with this disclosure;

FIG. 2 is a schematic flowchart of the method for predicting collision detection of moving path of machine tool in accordance with this disclosure;

FIG. 3 is a schematic flowchart of an embodiment of calculating the stop position of FIG. 2 in accordance with this disclosure;

FIG. 4 is a schematic flowchart of an embodiment of calculating the deceleration distance of FIG. 3 in accordance with this disclosure;

FIG. 5 is a schematic flowchart of another embodiment of calculating the deceleration distance of FIG. 3 in accordance with this disclosure;

FIG. 6 is a schematic flowchart of an embodiment of calculating the response time distance of FIG. 3 in accordance with this disclosure;

FIG. 7 is a schematic flowchart of an embodiment of calculating the response time distance after being determined as the acceleration/deceleration mode in FIG. 6 in accordance with this disclosure;

FIG. 8 is a schematic flowchart of an embodiment of the anti-collision detection of FIG. 2 in accordance with this disclosure;

FIG. 9 is a schematic view of an exemplary example of the anti-collision detection of FIG. 8; and

FIG. 10A and FIG. 10B show schematically and individually whether or not the stop position and the workpiece boundary position are interfered with each other in FIG. 8 in accordance with this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments listed below are described in detail with accompanying drawings, but these embodiments are not intended to limit the scope of the present disclosure. In addition, the accompanying drawings are for illustration purposes only and are not drawn according to the original dimensions. In order to facilitate understanding, the same components will be labeled with the same symbols in the following description.

Terms “include”, “have”, etc. mentioned in this disclosure are all open terms, which means simply “include but not limited to”.

In the description of different embodiments, when terms such as “first”, “second”, “third”, “fourth”, etc. are used to describe elements, they are only used to distinguish a plurality of elements from each other, and do not limit order or importance of these elements.

In the description of different embodiments, the so-called “couple” or “connect” may refer to two or more elements that are in direct physical or electrical contact with each other, or that are in indirect physical or electrical contact with each other, and may also refer to the mutual operation or action of two or more elements.

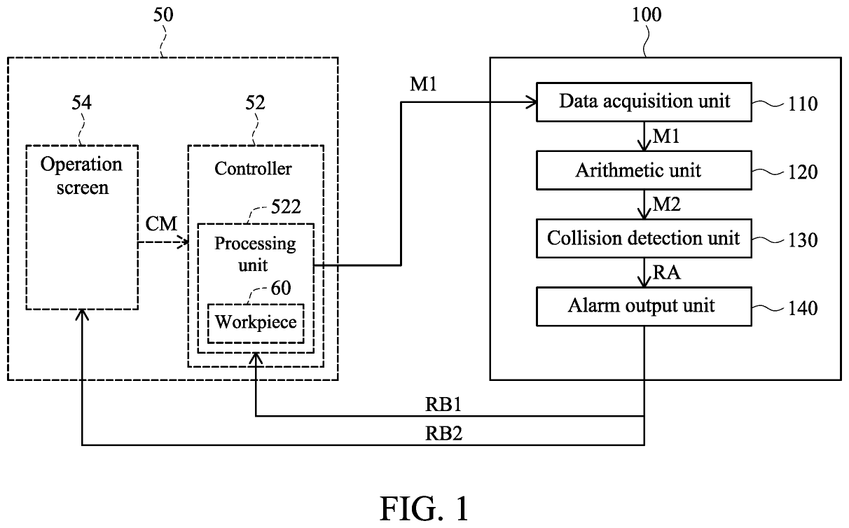

FIG. 1 is a schematic view of the system for predicting collision detection of moving path of machine tool in accordance with this disclosure. Referring to FIG. 1, the machine tool 50 can be any NC machine tool, such as a milling machine, a lathe, a boring machine, a grinder and a drilling machine. The machine tool 50 includes a controller 52 and an operation screen 54. The controller 52 having a processing unit 522 is connected with the operation screen 54. The controller 52 can be fulfilled by hardware (such as IC or CPU), software (such as programmed instructions to be performed by a processor), or a combination of aforesaid two, can utilize the operation screen 54 to place an instruction of the processing program, can select an automatic mode or a manual mode, and can monitor the processing. In this embodiment, the manual mode is prepared for the operator to reach the operation screen 54. For example, by inputting a move command CM, the machine tool 50 can be moved to complete machine calibration and establish operations in automation and simulation. The automatic mode can move axially the processing unit 522 through reading a program. In addition, the number of the machine tool 50 in this embodiment is one. However, in some other embodiments, the number of the machine tool 50 may be plural.

The controller 52 can read a processing program to control the processing unit 522 such as a processing spindle unit 522 for processing the workpiece 60. The processing unit 522 includes a spindle motor, a servo motor, a driver, a transformer and a solenoid valve of the machine tool 50. In this disclosure, the type or composition of the machine tool 50 can be various, but determined according to practical needs.

In this embodiment, the system for predicting collision detection of moving path of machine tool 100 used to connect the at least one machine tool 50 can be a physical circuit or a software program to be performed remotely by a physical circuit. The physical circuit can be a computer to connect the controller 52 of the machine tool 50 in a far end or a near end. For example, the system for predicting collision detection of moving path of machine tool 100 can be a cloud-end computer that can utilize a network connection to connect the controller 52 of the machine tool 50 so as to transmit data to each other, or can be an extension circuit built inside the controller 52 for performing various calculations.

The system for predicting collision detection of moving path of machine tool 100 includes a data acquisition unit 110, an arithmetic unit 120, a collision detection unit 130 and an alarm output unit 140. The data acquisition unit 110 is signally connected with the arithmetic unit 120, the arithmetic unit 120 is signally connected with the collision detection unit 130, and the collision detection unit 130 is signally connected with the alarm output unit 140. The data acquisition unit 110 can be an extension circuit, a foreign sensor or a mobile device disposed beside the operation screen 54 and signally connected with the controller 52 that is inserted into the controller 52 for capturing the motion information M1 of the processing unit 522.

Under such an arrangement, in this disclosure, the data acquisition unit 110 is configured for capturing the motion information M1 of the processing unit 522 so as to ensure the state of the processing unit 522. The data acquisition unit 110 transmits the motion information M1 to the arithmetic unit 120 such as a processing circuit or program, and the arithmetic unit 120 is utilized to receive the motion information M1 and further to obtain a stop position M2 after processing and calculating the motion information M1. The arithmetic unit 120 transmits the stop position M2 to the collision detection unit 130 such as a processing circuit or a program, and the collision detection unit 130 is utilized to receive the stop position M2 for performing the anti-collision detection. In the case that, according to the stop position M2, no collision with the workpiece 60 occurs, then the processing would be kept going. Otherwise, in the case that a collision with the workpiece 60 did occur according to the stop position M2, the collision detection unit 130 would issue a detection result RA to the alarm output unit 140. Then, the alarm output unit 140 would accordingly output an alarm information RB1 to the processing unit 522, and another alarm information RB2 to the operation screen 54 for alerting the operator. In this embodiment, the alarm output unit 140 can be a sound, a light-generating device or a screen display.

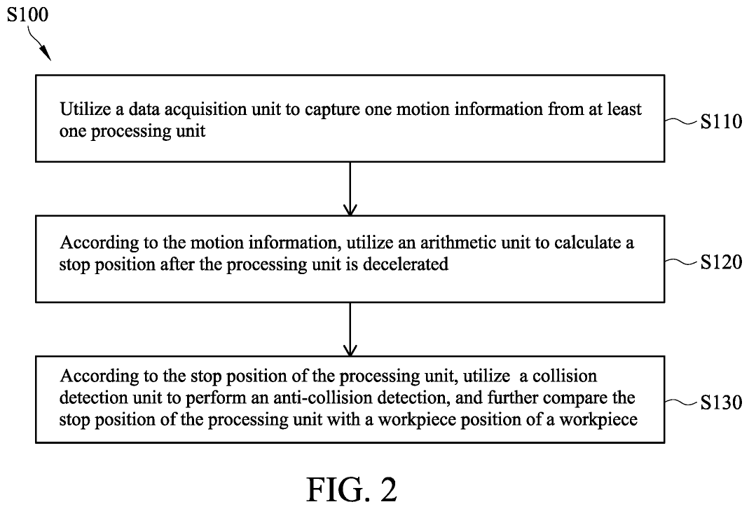

FIG. 2 is a schematic flowchart of the method for predicting collision detection of moving path of machine tool in accordance with this disclosure. Referring to FIG. 1 and FIG. 2, the method for predicting collision detection of moving path of machine tool S100 of this disclosure can be a software program to be read and then performed by a computer. In the embodiment, the method for predicting collision detection of moving path of machine tool S100 includes the following Step S110 to Step S130. Firstly, in Step S110, a data acquisition unit 110 is utilized to capture one motion information M1 from at least one processing unit 522. In this embodiment, the motion information M1 can include a current machine coordinate parameter, a motion axial feed parameter, an acceleration/deceleration parameter and a system response time parameter. The current machine coordinate parameter can realize the coordinate position of the axial mechanism of the processing unit 522, the motion axial feed parameter can realize the desired processing feed direction and the speed value, and the acceleration/deceleration parameter can realize whether or not an acceleration or deceleration exist. The system response time parameter is the estimated system response time for the system 100 to perform the transmission time; including the signal transmission time between the processing unit 522 and the data acquisition unit 110, the signal transmission time between the data acquisition unit 110 and the arithmetic unit 120, the signal transmission time between the arithmetic unit 120 and the collision detection unit 130, the signal transmission time between the collision detection unit 130 and the alarm output unit 140, and the signal transmission time between the alarm output unit 140 and the processing unit 522. Namely, the system response time is estimated with the change of transmission efficiency of the system for predicting collision detection of moving path of machine tool 100.

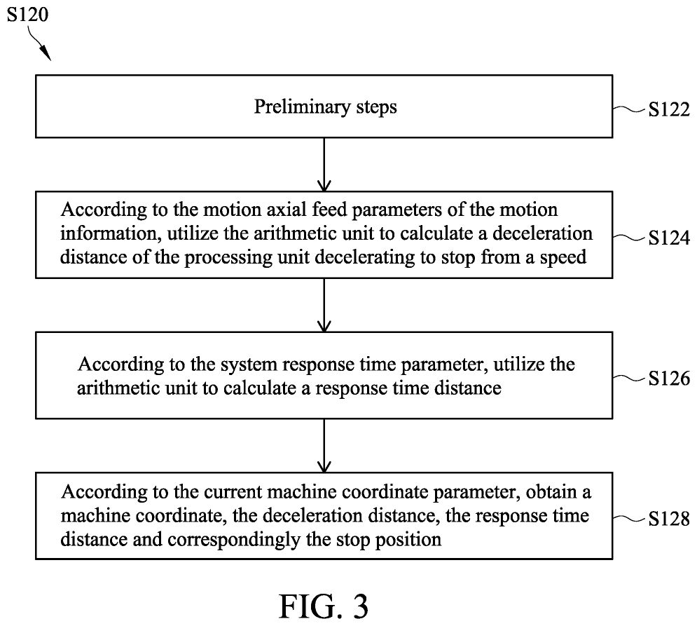

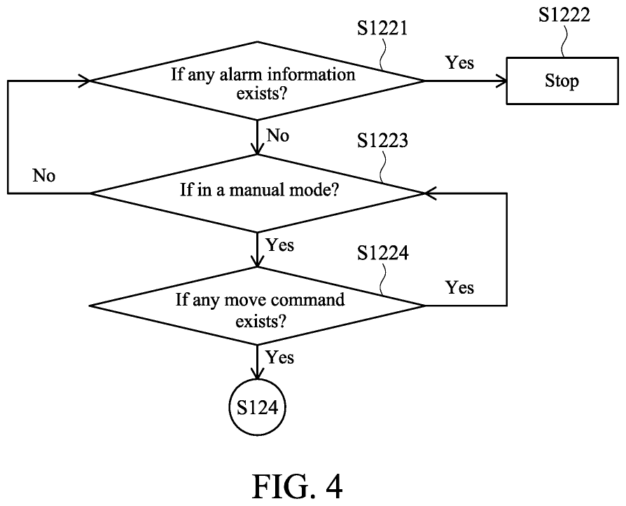

Then, in Step S120, according to each individual motion information M1, an arithmetic unit 120 is utilized to calculate a stop position of the corresponding processing unit 522 after being decelerated. The arithmetic unit 120 can be fulfilled by hardware (such as IC or CPU), software (such as programmed instructions to be performed by a processor), or a combination of aforesaid two. Practically, Step S120 further includes Step S122 to Step S128. As shown in FIG. 3, in performing the preliminary step of Step S122, the preliminary step is a judgement step prior to the calculations performed by the arithmetic unit 120. The preliminary step includes the following Step S1221 to Step S1224. As shown in FIG. 4, in Step S1221, determine whether or not the alarm information RB1 or RB2 of FIG. 1 exists. Namely, the arithmetic unit 120 judges if it is the time that the alarm output unit 140 is alarming the processing unit 522 or the operation screen 54. If positive, then perform Step S1222 and then suspend the calculation until the alarm is over. Since then, the data acquisition unit 110 is resumed to capture the motion information M1 of the processing unit 522. On the other hand, if negative, then it implies that no alarm information RB1, RB2 exists at this time, a4nd thus go to perform Step S1223 for determining whether or not in a manual mode. In this embodiment, the manual mode is a mode of providing the operation screen 54 to the operator for moving the machine tool 50. On the other hand, the automatic mode is a mode of reading the program for axially moving the processing unit 522. If the judgement of the arithmetic unit 120 is negative, then it is now in the automatic mode, and thus go back to Step S1221 for another determination. On the other hand, if the judgment of the arithmetic unit 120 is positive, then at this time the machine tool 50 is in the manual mode. At this time, the operator operates the operation screen to place instructions, and go to the next Step S1224 for determining whether or not a move command CM like the one shown in FIG. 1 exists. According to the motion axial feed parameter in the received motion information M1, the arithmetic unit 120 would realize the desired processing feed direction and the speed value, and thereby the existence of the move command CM can be determined. If the determination of the arithmetic unit 120 is negative, then go back to Step S1223 for another determination. On the other hand, if the determination of the arithmetic unit 120 is positive, then it is in the manual mode stored with a move command CM, and continue to perform Step S124.

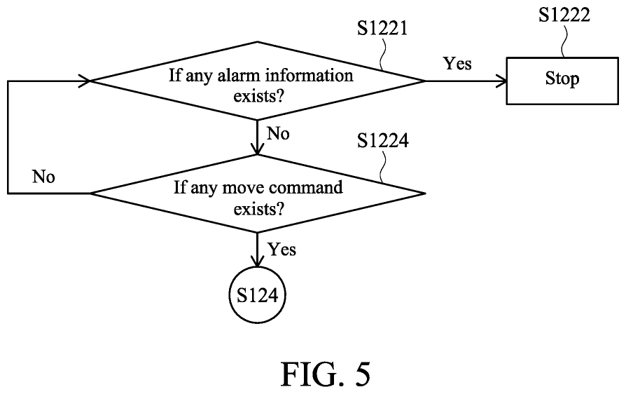

In the aforesaid embodiment, the machine tool 50 is supposed to have both the manual mode and the automatic mode. In the manual mode, the arithmetic unit 120 is allowed to perform calculations and the follow-up anti-collision mechanism, so that possible collision can be detected in advance to avoid collision damage and loss caused by human mistakes. In some other embodiments with only the automatic mode to perform steps shown in FIG. 5. In comparison with the embodiment shown in FIG. 4, the embodiment of FIG. 5 is less by a Step S1223; i.e., the step to judge the manual mode. As such, in FIG. 5, if the determination at Step S1221 is negative, then go direct to perform Step S1224; and, if the determination at Step S1221 is positive, then go to Step S1224. If the determination at Step S1224 is negative, then go back to perform Step S1221; and, otherwise, continue to perform Step S124.

Referring back to FIG. 3, after the determination at Step S122, then Step S124 is performed. In Step S124, according to the motion axial feed parameter in the motion information M1, the arithmetic unit 120 would be utilized to calculate a deceleration distance of each individual processing unit 522 decelerating to stop from a speed. The motion axial feed parameter can realize the desired processing feed direction and the speed value, and thus the deceleration distance can be derived. Thereupon, it can be understood that this disclosure is not limit to a fixed distance. Since the stop position of the processing unit 522 would vary in accordance with the instant speed value of the processing unit 522, thus a deceleration distance required for decelerating to stop from a speed value shall be calculated to act as a calculation factor for deriving the stop position.

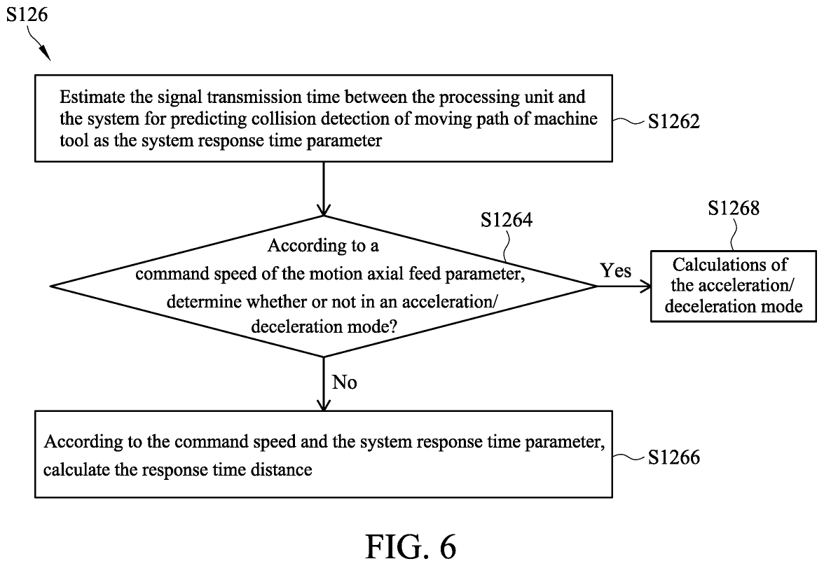

Then, in Step S126, according to the system response time parameter, the arithmetic unit 120 would calculate a response time distance. Step S126 further includes Step S1262 to Step S1268 as shown in FIG. 6. Firstly, in performing Step S1262, a signal transmission time between the processing unit 522 and the system for predicting collision detection of moving path of machine tool 100 is estimated to be the system response time parameter; including the signal transmission time between the processing unit 522 and the data acquisition unit 110, the signal transmission time between the data acquisition unit 110 and the arithmetic unit 120, the signal transmission time between the arithmetic unit 120 and the collision detection unit 130, the signal transmission time between the collision detection unit 130 and the alarm output unit 140, and the signal transmission time between the alarm output unit 140 and the processing unit 522. Namely, the system response time is estimated with the change of transmission efficiency of the system for predicting collision detection of moving path of machine tool 100.

Then, in Step S1264, according to a command speed in the motion axial feed parameter, determine whether or not in an acceleration/deceleration mode now. The arithmetic unit 120 reads the motion axial feed parameter in the motion information M1 to realize the command speed in the motion axial feed parameter. If a speed difference between the instant command speed and the previous command speed is zero, then an equal-speed state is determined, not an acceleration mode or a deceleration mode. In other embodiments, the arithmetic unit can compare a target speed to the command speed. If the target speed is equal to the command speed, then it is determined to be an equal-speed mode, not an acceleration/deceleration mode, then the determination would be negative, and then go to Step S1266. According to the command speed and the system response time parameter, the response time distance can be calculated. Namely, by having the command speed to multiply the system response time parameter, the response time distance.

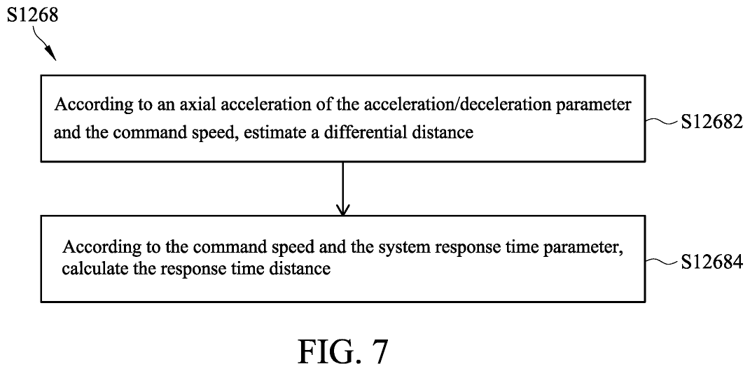

If the determination at the arithmetic unit 120 is positive (i.e., the speed difference between the instant command speed and the previous command speed is not zero, or the target speed is not equal to the command speed), then the acceleration/deceleration parameter in the motion information M1 is not zero, but has an axial acceleration. Then, in Step S1268, calculations of the acceleration/deceleration mode are performed. As shown in FIG. 7, in performing Step S12682, in comparison with the equal-speed mode, the use of accelerations and decelerations in the acceleration/deceleration mode to derive the response time distance shall estimate an additional differential distance in advance.

The differential distance is calculated by equation (1):1/2×AR², in which A stands for the axial acceleration in the acceleration/deceleration parameter, and R stands for the system response time parameter.

Then, in performing Step S12684, according to the command speed, the system response time parameter, and differential distance, the response time distance can be calculated. For example, if the speed difference between the instant command speed and the previous command speed is greater than zero, or the target speed is larger than the command speed, then it would be determined to be an acceleration state. At this time, by multiplying the system response time parameter with the same system response time parameter, and further adding the differential distance, then the response time distance can be obtained. On the other hand, if the speed difference between the instant command speed and the previous command speed is less than zero, or the target speed is less than the command speed, then it would be determined to be a deceleration state. At this time, by multiplying the system response time parameter with the same system response time parameter, and further subtracting the differential distance, then the response time distance can be obtained. In this disclosure, algorithms of the arithmetic unit 120 for the acceleration mode, the equal-speed mode and the deceleration mode might be different, such that decision errors to different speed patterns can be substantially reduced.

After the response time distance is obtained, referring back to FIG. 3, in Step S128, according to the current machine coordinate parameter, the machine coordinate, the deceleration distance and the response time distance, the corresponding stop position can be obtained. Thereupon, the stop position can be obtained by adding together the instant machine-coordinate position of the processing unit 522 of FIG. 1, the deceleration distance and the response time distance. Namely, for the processing unit 522 to decelerate to stop according to the motion information M1, then the stop position would be M2.

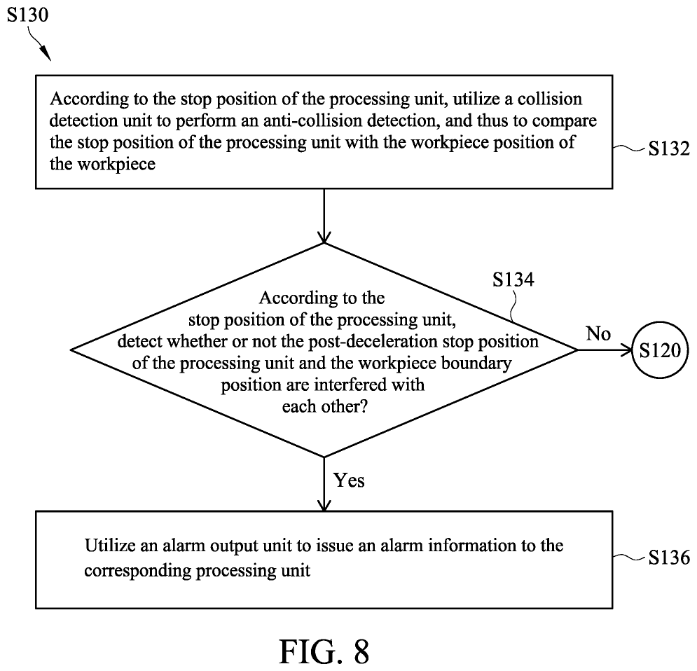

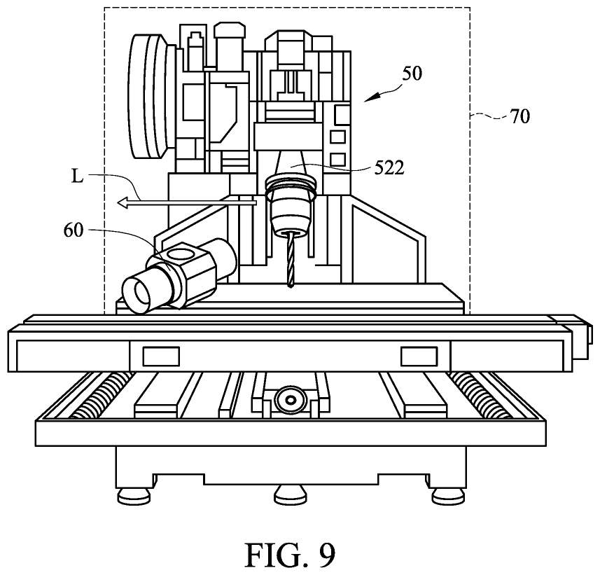

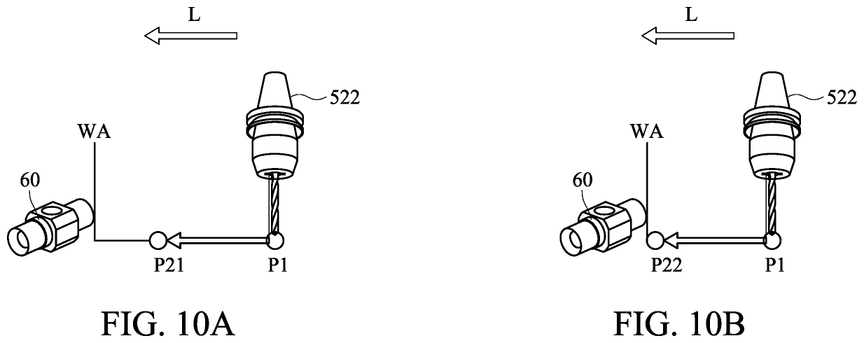

After obtaining the stop position M2, referring back to FIG. 1 and FIG. 2, in performing Step S130, according to different stop positions M2 of the corresponding processing units 522, utilize a collision detection unit 130 to perform an anti-collision detection, and to compare the stop positions M2 of individual processing units 522 to the corresponding workpiece positions of the workpieces. The workpiece position can be a workpiece boundary position or any other specific position for detection. The arithmetic unit 120 transmits the stop positions M2 to the collision detection unit 130 so as to perform the anti-collision detection. Step S130 further includes Step S132 to Step S136 of FIG. 8, and also refer to FIG. 1, FIG. 9 to FIG. 10B.

In performing Step S132, according to a contour information 70 of each individual processing unit 522, the workpiece boundary position WA of the workpiece 60 with respect to the corresponding processing unit 522 can be obtained (FIG. 10A or FIG. 10B). The motion axial feed parameter of the processing unit 522 (for example, an axial mechanism) of the machine tool 50 includes the desired processing feed direction and the speed value toward a moving direction L for processing the workpiece 60. The collision detection unit 130 can utilize CAD to prepare in advance the e-machine tool contour-simulated drawing, such that a contour information 70 of the processing unit 522 can be obtained. This contour information 70 including related information (such as the workpiece boundary position WA of the workpiece 60) can form a contact judgment basis during the processing between the processing unit 522 and the relative objects (such as the workpiece 60), for determining if a collision occurs at the protective processing unit 522.

It should be noted that, for the convenience and clarity of explanation, the thickness or size of each component in FIG. 10A and FIG. 10B is exaggerated, omitted or schematically expressed, and the size of each component is not entirely its actual value and size.

Then, in performing Step S134, according to the stop position M2 of each individual processing unit 522, examine whether or not the stop position M2 of each individual processing unit 522 after being decelerated and the workpiece boundary position WA are interfered with each other. Namely, during a moving period, the collision detection unit 130 would detect if the boundary of the processing unit 522 and the workpiece boundary position WA of the workpiece 60 are interfered with each other.

As shown in FIG. 10A, from the current machine coordinate parameter in the motion information M1, it can be realized that the machine coordinate of the processing unit 522 is the initial position information P1. According to the stop position M2, the arithmetic unit 120 would calculate to realize that the stop position M2 of the processing unit 522 after being decelerated has the position information P21. At this time, the position information P21 and the workpiece boundary position WA of the workpiece 60 are not interfered with each other. As the negative judgment by the arithmetic unit 120 in Step S134 in one embodiment, the method would go back to perform Step S120 of FIG. 1.

On the other hand, as shown in FIG. 10B, the stop position of the processing unit 522 after being decelerated is defined as the position information P22. At this time, the position information P22 and the workpiece boundary position WA of the workpiece 60 are interfered with each other. As the positive judgment by the arithmetic unit 120 in Step S134, it implies that a collision is true. As shown in FIG. 1, the collision detection unit 130 would issue a detection result RA to the alarm output unit 140, and then continue to perform Step S136, where the alarm output unit 140 is utilized to output an alarm information RB1 to the processing unit 522, and another alarm information RB2 to the operation screen 54 to alert the operator.

In summary, the method and system for predicting collision detection of moving path of machine tool provided in this disclosure can detect collisions in advance so as able to predict a stop position after a deceleration and further ensure to avoid an unexpected collision. In addition, the method and system can prevent an improper path scheme with irrelevant machine tool move commands in the manual mode from damaging the machine tool or the workpiece. Namely, the processing utilization rate can be substantially maintained.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A method for predicting collision detection of moving path of machine tool, performed after being read by a computer, the computer being applicable to connect a machine tool, the machine tool including a controller, the controller including at least one processing unit, comprising the steps of:
utilizing a data acquisition unit to capture a motion information of the at least one processing unit, the motion information including a current machine coordinate parameter, a motion axial feed parameter and a system response time parameter;
according to the motion information, utilizing an arithmetic unit to calculate a stop position of the at least one processing unit after being decelerated; and
according to the stop position of the at least one processing unit, utilizing a collision detection unit to perform an anti-collision detection, comparing the stop position of the at least one processing unit with a workpiece position of a workpiece.

2. The method for predicting collision detection of moving path of machine tool of claim 1, further including a step of: utilizing an alarm output unit to output an alarm information to the processing unit correspondingly.

3. The method for predicting collision detection of moving path of machine tool of claim 1, wherein the step of utilizing an arithmetic unit to calculate the stop position of the at least one processing unit after being decelerated further includes the following steps:
according to the motion axial feed parameter of the motion information, utilizing the arithmetic unit to calculate a deceleration distance for the at least one processing unit to decelerate to zero from a speed value; and
according to the system response time parameter, utilizing the arithmetic unit to calculate a response time distance.

4. The method for predicting collision detection of moving path of machine tool of claim 3, wherein the step of utilizing the arithmetic unit to calculate the response time distance further includes a step of: estimating a signal transmission time between the at least one processing unit and a system for predicting collision detection of moving path of machine tool as the system response time parameter.

5. The method for predicting collision detection of moving path of machine tool of claim 4, after the step of estimating the signal transmission time between the at least one processing unit and the system for predicting collision detection of moving path of machine tool as the system response time parameter, further including the steps of:
upon when a command speed of the motion axial feed parameter is within an equal-speed mode, then calculating the response time distance according to the command speed and the system response time parameter; and
according to the current machine coordinate parameter, obtaining a machine coordinate, the deceleration distance and the response time distance so as to derive correspondingly the stop position.

6. The method for predicting collision detection of moving path of machine tool of claim 4, after the step of estimating the signal transmission time between the at least one processing unit and the system for predicting collision detection of moving path of machine tool as the system response time parameter, further including the steps of:
upon when a command speed of the motion axial feed parameter is within an acceleration/deceleration mode, then estimating a differential distance according to an axial acceleration in the acceleration/deceleration parameter and the command speed;
according to the command speed, the system response time parameter and the differential distance, calculating the response time distance; and
according to the current machine coordinate parameter, obtaining a machine coordinate, the deceleration distance and the response time distance so as to derive correspondingly the stop position.

7. The method for predicting collision detection of moving path of machine tool of claim 1, before the step of utilizing the arithmetic unit to calculate the stop position of the at least one processing unit after being decelerated, further including the steps of:
upon when an alarm information exists, then stopping the method; and
upon when an alarm information does not exist, and a move command exists in a manual mode, then continuing to utilizing the arithmetic unit to calculate the stop position of the at least one processing unit after being decelerated.

8. The method for predicting collision detection of moving path of machine tool of claim 1, wherein the step of, according to the stop position of the at least one processing unit, utilizing the collision detection unit to perform the anti-collision, comparing the stop position of the at least one processing unit with the workpiece position of the workpiece further includes:
according to a contour information of the at least one processing unit, comparing the stop position of the at least one processing unit with the workpiece position of the workpiece so as to obtain a workpiece boundary position of the workpiece corresponding to the at least one processing unit; and
according to the stop position of the at least one processing unit, detecting whether or not the stop position of the at least one processing unit after being decelerated and the workpiece boundary position are interfered with each other.

9. A system for predicting collision detection of moving path of machine tool, applicable to connect a machine tool, the machine tool including a controller, the controller including at least one processing unit, comprising:
a data acquisition unit, configured for capturing a motion information of the at least one processing unit;
an arithmetic unit, signally connected with the data acquisition unit, configured for receiving the motion information and calculating a stop position of the at least one processing unit after being decelerated according to the motion information; and
a collision detection unit, signally connected with the arithmetic unit, configured for performing an anti-collision detection the collision detection unit according to the stop position of the at least one processing unit and comparing the position of the at least one processing unit and a workpiece position of a workpiece.

10. The system for predicting collision detection of moving path of machine tool of claim 9, further including an alarm output unit, signally connected with the collision detection unit, configured for outputting an alarm information to the at least one processing unit.
